(19) United States
(12) Patent Application Publication
(10) Pub. No.: US 2024/0311559 A1
(43) Pub. Date: Sep. 19, 2024

(54) ENTERPRISE-SPECIFIC CONTEXT-AWARE AUGMENTED ANALYTICS

(71) Applicant: Aible Inc., Pleasanton, CA (US)

(72) Inventors: Arijit Sengupta, San Carlos, CA (US); Richard Cooke, Hayward, CA (US); Joseph Veltkamp, Corte Madera, CA (US); Jonathan Wray, Leander, TX (US); John Delaney, El Cerrito, CA (US)

(21) Appl. No.: 18/606,523

(22) Filed: Mar. 15, 2024

Related U.S. Application Data
(60) Provisional application No. 63/452,417, filed on Mar. 15, 2023.

(51) Int. Cl. G06F 40/20; G06Q 10/0639

(52) U.S. Cl. CPC G06F 40/20; G06Q 10/06393

(57) ABSTRACT

Data characterizing a query can be received. A dataset specific to an enterprise and a parameter set specific to the enterprise can be determined using an information model. A query response using a foundational model, the dataset specific to the enterprise, and the parameter set specific to the enterprise can be determined. The query response can be provided to a user. Related apparatus, systems, techniques, and articles are also described.

### CROSS REFERENCE TO RELATED APPLICATIONS

This application claims priority to U.S. Provisional Patent Application No. 63/452,417, filed Mar. 15, 2023, and entitled “Enterprise-Specific Context-Aware Augmented Analytics,” the disclosures of this application are incorporated herein by reference.

### TECHNICAL FIELD

The subject matter described herein relates to an enterprise-specific context-aware augmented analytics system.

### BACKGROUND

Artificial intelligence (AI) based foundational models (e.g., multimodal models and large language models) often provide generalized summaries to specific user initiated queries rather than a direct answer to the user initiated query. Additionally, AI based foundational models may provide inaccurate responses to a user as they have been trained in a closed-universe of data, which may become stale between the time the AI system was trained and when it is used. Additionally, at times, an AI based foundational models may produce output that is entirely irrelevant to the conversation or query initiated by a user, in what is commonly referred to as a hallucination, where AI based foundational models simply make up information and present it confidently to a user as if it were fact. In some instances, AI systems may also lack the ability to distinguish between ground truths and facts and false statements contained within the data that it is trained on. Additionally, bias within the training data may result in biased responses in AI based foundational models. Further, AI systems may also raise privacy concerns in that in order to have relevant, topical answers to queries, the AI systems may need to be provided with data that is relevant and topical, and often times that data may include sensitive data such as data that includes personally identifying information or data that is particularized to an organization or enterprise and is needed to be kept secret in order to preserve competitive advantages or meet compliance requirements.

### SUMMARY

In an aspect, data characterizing a query is received at a user interface. A dataset characterizing an enterprise associated with the received query is obtained and a dataset characterizing a parameter set associated with the received query is also obtained by an informational model. A response to the received query is determined using a foundational model based on the obtained data sets characterizing the enterprise and the parameter set. The determined response to the received query is provided to a user.

One or more of the following features can be included in any feasible combination. For example, the dataset specific to the enterprise and the parameter set specific to the enterprise may be determined by querying the information model with the data characterizing the query, receiving at least one of data related to the enterprise or parameters related to the enterprise and responsive to the query. In another example, the information model may be communicatively coupled to at least one of a network or a database associated with the enterprise, and the foundational model has limited access to the network or database associated with the enterprise. In another example, the query response may be validated by encoding at least one of the dataset specific to the enterprise or the parameter set specific to the enterprise with an identifier, instructing the foundational model to maintain the identifier in its generated response, and receiving the identifier within the query response. In another example, determining the query response further includes using the foundational model on data characterizing a prior query or a prior query response. Validating the generated query response can include adjusting the language, context, or variable naming of the query response to conform to the language, context, or variable naming conventions of the enterprise. The foundational model may include at least one of a generative model, a multimodal model, a reinforcement learning model, transfer learning model, and a large language model. The information model may include at least one of a descriptive model, diagnostic model, predictive model, prescriptive model, optimization model, a cost-benefit model, a constraint model, a digital twin. The optimization model may include a set of models trained on a dataset using a set of resourcing levels and performance indicators. The cost-benefit model may include a model trained to classify an event as belonging to a first event type or a second event type, where the classification of the event is responsive to at least one of an impact of correctly treating the event as belonging to a first event, an impact of erroneously treating the event as belonging to the first event, a cost of erroneously treating an event as not belonging to the first event, and a benefit of correctly treating an event as not belonging to the first event. Optionally, the constraint model may include a model trained based on one or more resource constraints of the enterprise. The information model query may be generated based on the received user generated query by applying context specific data. The dataset specific to the enterprise may include at least one of information related to the results of group-by, drill-down, benchmark, statistical association, values, and other related analytical queries. Optionally, at least one of the dataset specific to the enterprise and the parameter set specific to the enterprise may include text summaries, images, number, tables, or formulae. The query may be provided by a user interface in natural language form. The parameter set specific to the enterprise may include key performance indicators for the enterprise. The foundational model may incorporate a learning model including reinforcement learning from human feedback. The query response may be provided to the user interface in natural language form. Parameters of the foundational model may be modified based on the parameter set specific to the enterprise. At least a portion of the foundational model may be trained based on the dataset specific to the enterprise. The foundational model may include a transfer learning model and the dataset specific to the enterprise may include additional training data for the transfer learning model.

Disclosed is an enterprise-specific context-aware dialogue management system that can applied to multiple business applications.

Non-transitory computer program products (e.g., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating CLAIM 1;

FIG. 2 is a system block diagram illustrating an example system; AND

FIGS. 3-19 illustrate various example user interfaces illustrating example implementations of the current subject matter.

Like reference symbols in the various drawings indicate like elements.

### DETAILED DESCRIPTION

Artificial intelligence (AI) based foundational models may include multimodal models, large language models, chatbots, voice assistants, and the like. While these AI based foundational models are being broadly adopted, they continue to be limited by their training data, training processes, and use. For example, these AI based foundational models are limited in their ability to provide direct answers to user initiated queries and instead often provide generalized summaries. Additionally, conventional AI based foundational models are limited in their ability to provide accurate responses to a user because they have often been trained in a closed-universe of data, which may become stale between the time the AI system was trained and when it is used. Foundational AI systems may also suffer from ‘hallucinations’ where the models simply make up information and present it confidently. In some instances, AI systems may also be limited by their lack of ability to distinguish between ground truths and facts, and false statements contained within the data that it is trained on. Additionally, bias within the training data may result in biased responses in AI based foundational models. Indeed, the inaccuracy and unpredictability of AI-generated responses to user queries in foundational models often leads to AI-generated responses being mediated by a human expert, which results in reduction of any benefits associated with having no human intervention.

Further, AI systems may be limited in that, in order to have relevant, topical answers to queries, the AI systems may need to be provided with data that is relevant and topical. However, relevant and topical training data may also include sensitive data such as data that includes personally identifying information (e.g., social security numbers, addresses, birthdates) or data that is particularized to an organization or enterprise (e.g., sales data, revenue data, employee salary data, medical data). Often the relevant data is required to be kept secret in order to preserve competitive advantages or meet regulatory compliance requirements. Thus, conventional AI based foundational models may present privacy challenges. Additionally, at times, conventional AI based foundational models may produce output that is entirely irrelevant to the conversation or query initiated by a user, or where the output is unmoored in reality, in what is commonly referred to as a hallucination.

Some implementations of the current subject matter include an approach to querying a large language model that includes using an information model to provide enterprise specific contextual and/or supplemental data alongside a user query to the large language model that can enable preservation of data privacy and leverages organizational or enterprise level data to provide more accurate and/or topical responses to a user. In some implementations, the contextual and/or supplemental data can allow for validation of the large language results, thereby enabling identification of hallucinations and improving system performance. Some implementations described herein provide an improved artificial intelligence (AI) based conversational dialogue system that allows for conversing with a user in natural language. In addition, the disclosed systems and methods provide a system which provides validation of AI generated summaries presented to a user, preserves data privacy, and leverages organizational or enterprise level data to provide more accurate and/or topical responses to a user.

For example, in some embodiments, an exemplary method for enterprise-specific context-aware dialogue management may include a control system that interfaces with a user interface that receives dialogue based queries from a user and provides a user with an answer to their query. The control system may interface between the user interface and an information model that provides enterprise specific content and moderation. The control system may also interface between the user interface and a foundational model. The control system may provide context-specific data and parameters from the information model to the foundational model to receive more context-specific answers to a user query from the foundational model. The control system may moderate and validate the context-specific answers received from the foundational model. The control system may then provide the user with a context-specific dialogue that answers their initial query. The control system may also use the foundational model to interpret the user input in a way that the information model can understand.

While foundational models (e.g., large language models, generative AI models) are often able to communicate in a way that seems human and synthesize information from a vast variety of sources, foundational models typically do not have access to enterprise-specific organizational context or the latest information. On the other hand, information models may have a superior grasp of organizational context as is represented in an organization's data and have metrics and methods for processing goals and constraints. Further, information models may be more agile in recognizing changes in data. However, by themselves information models may not be able to provide user-friendly ways of understanding the data and cannot use external contextual information. To that end, in some embodiments, the systems and methods described herein may provide conversational context-aware problem solving that is able to incorporate both external, global contexts, and internal, enterprise-specific contexts.

For example, a foundational model may be trained on vast amount of language data in a training process that is expensive and happens once. The training process for the foundational model may not guarantee data privacy, security or model explainability. On the other hand, the training process for an information model run may be performed in a virtual private cloud or similar architectural structure that will ensure data privacy and security. Further, the information model may be configured to digest various amounts of data, small or large, depending on what is required by an underlying enterprise. The information model may also be configured to provide fast analytics to an enterprise by digesting enterprise information and building AI-based models at low computational costs and at higher speeds.

For example, in a foundational model, a user query such as “how can I increase revenue by 15%” may be met with suggestions to expand product and service offerings, increase sales and marketing efforts, upsell or cross-sell to current customers, improve pricing strategy, and increase customer satisfaction and retention. The computer-generated answers to the user query are non-specific, broad, and general. The same query to an information model on an enterprise system may provide sales data, allow for curation by revenue, cost-benefit tradeoff, best practice or language blueprints, or constraints by spend, and yet produce charts and other technical materials that are not as easily interpreted by an end user.

In some embodiments, the control system may curate the data provided to the foundational model, in a way that the foundational model becomes aware of what is important. For example, in some embodiments, the control system and/or the information model may make choices over what data to include or omit, how the data is organized and presented, and what importance or weighting is given to each subsection of the data that is provided to the foundational model. The control system may also generate more context-specific queries for the foundational model that allows for both fine tuning and reinforcement learning and training of the foundational model. For example, in some embodiments, a user may insert a query that says “tell me how I can increase revenue by 15%.” However, the disclosed system may augment the user query with data that is context-specific. For example, the system may augment the user query with information about the user's enterprise and related constraints. The resulting output may provide answers to user queries that are both strategic and tactical and combine the data and output that is provided by the information model and the foundational model. For example, in response to the query above, the system may provide recommendations for 5% revenue increase in the current quarter, followed by 15% revenue increase in the next quarter by making strategic maneuvers such as increasing market spend in one region and cutting spending in another region, increasing sales teams in one region, and tracking user compliance with the recommendations.

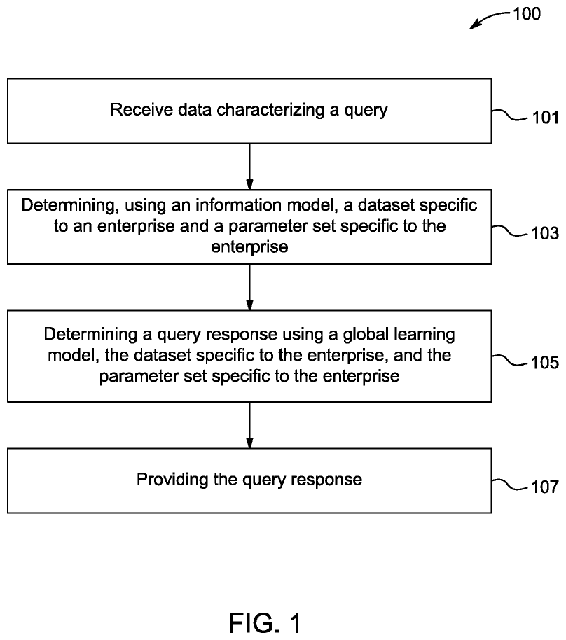

FIG. 1 is a process flow diagram illustrating an exemplary method of enterprise-specific context-aware dialogue management. The method 100 includes the first step 101 of receiving data characterizing a query.

In a second step 103 of the method 100, a dataset specific to an enterprise and parameter set specific to an enterprise may be determined using an information model. The information model may include enterprise specific information. In some embodiments, the information model may have access to a database that includes the enterprise specific information. The information model can include information on variables and parameters that impact key performance indicators for an enterprise. The information model may have access to information related to the results of group-by, drill-down, benchmark, statistical association and other related types of queries typically used in analytics.

In some embodiments, determining the dataset specific to the enterprise and the parameter set specific to the enterprise may include querying the information model with the data characterizing the query and receiving at least one of data related to the enterprise or parameters related to the enterprise and responsive to the query.

In generating a dataset specific to the enterprise, the information model may evaluate the enterprise-specific data that it has access to and determine what subset of the available data is required to answer the user query. For example, the information model may determine what parameters may form a set of fields that is required to explain a key performance indicator. For example, to explain a key performance indicator such as revenue, the parameter set may include sales expenditure, marketing expenditure, and the like. The dataset specific to the enterprise may include at least one of key performance indicators, revenue, win rate, statistics, inventory levels, logistics datasets, collections metrics, lead conversions, and the like.

In some embodiments, the information model may also be configured to detect and alleviate data quality issues when determining the dataset specific to the enterprise. For example, the information model may detect and account for outliers, missing values, and the like. Some approaches to automatically learning aspects of the information model is described in U.S. application Ser. No. 17/194,920, filed Mar. 8, 2021, and entitled “Automatically Learning Process Characteristics for Model Optimization”, the entire contents of which is hereby expressly incorporated by reference herein.

The information model can include descriptive models, diagnostic models, predictive models, optimization models, prescriptive models, cost-benefit models, and/or constraint models. Optimization models may include those that balance cost-benefits and constraints. The information model may produce one or more charts that provide insight into how an enterprise may be affected under different strategies and cost benefit assumptions.

For example, information models may include those discussed in U.S. patent application Ser. No. 16/512,647 filed on Jul. 16, 2019, entitled “ANALYZING PERFORMANCE OF MODELS TRAINED WITH VARYING CONSTRAINTS,” the contents of which are hereby incorporated by reference, in their entirety. For example, information models may include a set of models trained on a dataset using a set of resourcing levels. In some embodiments, the set of resourcing levels can specify a condition on outputs of models in the set of models. Performance of the set of models can be assessed using the set of resourcing levels. A feasible performance region can be determined using the assessment, and the resulting information model may be based on the feasible performance region. The information model may also be generated based on a dataset, an optimization function, and a set of constraints. The set of constraints can specify a condition on outputs of models in a set of models. A set of models can be trained using the optimization function and the set of constraints. The set of models can be provided. Each constraint in the set of constraints can be associated with at least one model in the set of models. And the set of models may be incorporated into the information model.

In some embodiments, the information model may automatically detect changes in the underlying data and the model may be rerun, retrained, or adjusted to accommodate for the underlying data changes. In some embodiments, the information model may be compatible with various data types. For example, the information model may log all user interactions with the system (e.g., data transformations, charts viewed, shared, strategies, benefits, costs, constraints) and learn from the user interactions with the system. In some embodiments, the information model may provide “micro-tasks” or analytical or data science based tasks for completion by a user or enterprise. Further examples of “micro-tasks” are provided in U.S. patent application Ser. No. 17/813,669 filed on Jul. 20, 2022, entitled “USER INTERFACE FOR COLLABORATIVE ANALYTICS PLATFORM,” the entire contents of which are hereby incorporated by reference. Each “micro-task” may form a step in a multi-step analytical process that can be provided to a user via a graphical user interface. For example, the multi-step analytical process can include importing a dataset, building a model using the dataset, and/or deploying the model to operate on live data. Other actions can be performed in the multi-step analytics process, including, without limitation, marketing tasks, sales tasks, churn tasks, customer service tasks, supply chain tasks, and the like.

In some embodiments, the information model may include an optimization model that includes a set of models trained on a dataset using a set of resourcing levels and performance indicators.

In some embodiments, the information model may include a cost-benefit model that includes a model trained to classify an event as belonging to a first event type or a second event type, wherein the classification of the event is responsive to at least one of an impact of correctly treating the event as belonging to a first event type, an impact of erroneously treating the event as belonging to the first event type, a cost of erroneously treating an event as not belonging to the first event type, and a benefit of correctly treating an event as not belonging to the first event type.

In some embodiments, the information model includes a constraint model trained based on one or more resource constraints of the enterprise.

In some embodiments, datasets, parameter sets, and information generated by the information model may be provided to the user for curation prior to being provided to the foundational model by the control system. For example, the user interface may provide datasets, parameter sets, and information for display to the user and the user can eliminate charts or variables or scenarios from consideration based on their domain knowledge. For example, the user may know that a certain pattern is due to a data quality issue or a variable is redundant within the same parameter set. In some embodiments, the user can also set the k-anonymity threshold to different levels and see how the charts change (discussed below). This may correspond directly to changes in the dataset that is provided to the foundational model.

In a third step 105 of the method 100 a query response may be determined using a foundational model, the dataset specific to the enterprise and the parameter set specific to the enterprise. The foundational model, which may also be referred to herein as a foundational model, may include a class of large language models, a generative model, a reinforcement learning model, transfer learning model, generative AI based technologies and the like.

In some embodiments, the method 100 may also validate the query response. Validating the query response may include encoding either or both of the dataset specific to the enterprise or the parameter set specific to the enterprise with an identifier and receiving the identifier within the determined query response.

In some embodiments, determining the query response may also include using the foundational model on data characterizing a prior query or a prior query response.

In some embodiments, the foundational model may not have access to the database including enterprise specific information that the information model has access to. In this manner, the enterprise specific information may be kept private from the foundational model.

In some embodiments, the foundational model may have limited access to the enterprise specific information. For example, the enterprise specific information can be used to train the information model securely within an enterprise's own virtual private cloud, or the like. Because the foundational model does not have access to the enterprise specific data, privacy concerns are alleviated.

Additionally, in some embodiments k-anonymity may be used to ensure that foundational models do not have access to individual private data. For example, the information model may calculate all charts, train models, and develop statistics that enforce the concept of k-anonymity. Accordingly, data and information for populations less than k would not be included in the analysis or passed to the foundational model. For example, if k was set to 10, and there were less than 10 patients with a specific disease in a specific zip code, the chart of diseases by zip code would not have an observation for that specific combination. In this manner, the disclosed systems and methods may provide enhanced privacy.

In addition to k-anonymity, the disclosed systems and methods may also use mapping and/or masking to provide improved privacy. For example, the foundational model may be prevented from learning on the underlying enterprise data. Additionally, in some embodiments, variable names and values may be masked. For example, variable names may be replaced by masked identifiers and values may be masked by multiplication by a random number. The masking of identifiers and values may be performed by the control system prior to sending the dataset and parameter set to the foundational model. Further, in some embodiments, control system may reverse the masking prior to providing a response to the user query on the user interface.

Although techniques such as k-anonymity, mapping/masking, and scaling are discussed herein, it is contemplated that alternative methods for providing privacy with the information model and control system may be used. Some implementations of the disclosed systems and methods allow a user to make different choices such as the level of anonymity, whether or not to mask variable names, or values, or numbers to decide how much information to obscure and can easily test the impact of different levels of privacy protection on the quality of the final output.

The query response may be determined using the foundational model based on the dataset specific to the enterprise and/or the parameter set specific to the enterprise. In some embodiments, the dataset specific to the enterprise and/or the parameter set specific to the enterprise may be provided to the foundational model in the form of text summaries, images, numbers, tables, formulae, and the like, or any combination thereof.

In a fourth step 107 of the method 100 the query response may be provided. For example, in some embodiments, the query response may be provided to a user interface. In some embodiments, the query response may be provided to a user interface in natural language form. Accordingly, a user may be able to use conversational language with the described systems and methods.

In some embodiments, the user interface may include any hardware or software components for communication between a user and the system described herein. Examples of user interfaces include applications, software programs, web applications, downloadable applications, and the like that may be present on a user interface device. Examples of user interface devices, include, but are not limited to laptops, desktop computers, smartphones, tablets, car service devices, television devices, video game controller systems, coffee machines, refrigerators, and the like. The user interface may be in the form of a voice assistant, chat assistant, email assistant, image generation, and the like.

In some embodiments, the user interface may allow for enterprise specific users or enterprise customer users to confirm and accept the output of the combined system, the query response.

In some embodiments, the foundational model may be trained or updated based on the dataset specific to the enterprise via fine tuning, transfer learning or other approaches. Additionally, in some embodiments, the foundational model may include a reinforcement learning model, and the dataset specific to the enterprise and user feedback may provide additional training data for the reinforcement learning model. Similarly, in some embodiments, the foundational model may be modified based on the parameter set specific to the enterprise.

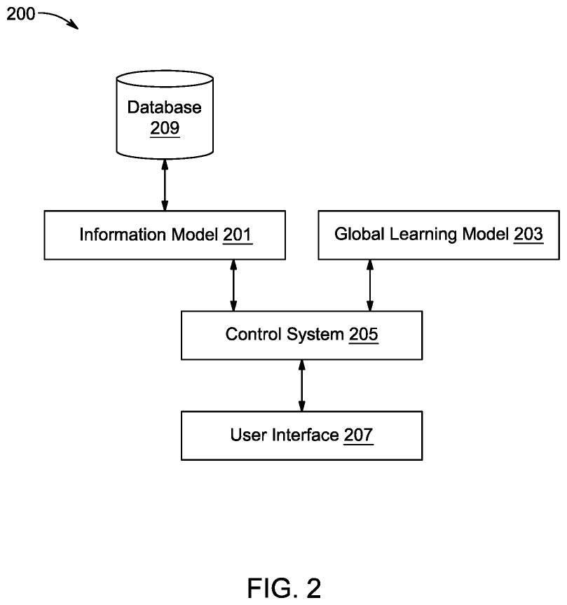

FIG. 2 is a system block diagram illustrating an example implementation of a system 200 for providing context-specific dialogues. For example, the system 200 may include an information model 201, a foundational model 203 and a control system 205. In some embodiments, the information model 201 may be communicatively coupled to a database 209 that includes enterprise specific data. The control system 205 may interface between the information model 201 and the foundational model 203. For example, the control system 205 may use the foundational model 203 to generate human comprehensible insights based on data and parameter sets provided by the information model 201. Additionally, the control system 205 may use the information model 201 to confirm the accuracy of output generated by the foundational model 203. Additionally, the user interface 207 may be configured to allow inexpert users to confirm and accept the output of the combined system without requiring any data science expertise.

In some embodiments, the control system 205 may utilize the explainability of the information model 201 such as information regarding its expected impact, bias, accuracy, fairness, transparency and outcomes. For example, the control system 205 may use information related to the explainability of information model 201 to verify or double check the output generated by the foundational model 203. Yet, the output generated by the foundational model 203 may not be explainable. In some embodiments, explainability may indicate that the decisions taken by the model in generating their output can be traced back to specific facts and patterns in the data the model was provided. In some embodiments, if an explainable AI model validates the output of an unexplainable AI model, a user may feel more comfortable using that output.

In some embodiments the control system 205 may be configured to encode an identifier to the data and/or parameter set provided by the information model to the foundational model. The encoded identifier may be a unique ID for each chart, narrative text, model, scenario or the like, that is produced by the information model and provided to the foundational model by the control system 205. The foundational model 203 may be configured to generate a response to the user query that maintains the unique ID for the data and information that was incorporated into the response. The unique ID may be displayed as a tag, highlight, overlay or any other suitable means.

In some embodiments, the control system 205 may validate the information that is provided by the foundational model 203. For example, the user interface 207 may present the user with a summary and response to the query after the control system 205 has confirmed that each section of the summary contained the unique ID as requested. Further, the control system 205 may use this unique ID as maintained by the foundational model to check and validate that the facts in the summary and response generated by the foundational model 203 matches the facts in the original chart, narrative text, or scenario the summary was supposedly derived from and provided by the information model 201. In this manner, the described systems and methods can protect against extraneous facts and hallucinations that are common to AI based generative systems.

In some embodiments, the control system 205 may mask or map variable names. The control system 205 may also convert the generalized user queries provided by the user into use-case specific language, or context. For example, the control system 205 may apply a mapping to replace the natural language inputs provided by a user into variable names that are consistent with the terminology used in the enterprise system. For example, a blueprint, which is described in U.S. Pat. No. 11,409,549, which granted on Aug. 9, 2022, and entitled “INTERFACE FOR GENERATING MODELS WITH CUSTOMIZABLE INTERFACE CONFIGURATIONS” the entire contents of which is hereby expressly incorporated by reference herein, may be used to apply the mapping to replace the natural language inputs provided by a user into variable names. In some embodiments, the enterprise specific variable names may be provided to the user via the user interface 207 for confirmation, adjustment, or to provide alternative recommendations for replacement variable names.

In some embodiments, the user interface 207 may be further configured such that users are provided with a graphical user interface where they can browse the provided answer to the user query and simultaneously be provided with a summary of the relevant sections of the original source chart, narrative text, or scenario from the dataset and parameter set determined by the information model 201. In some embodiments the relevant sections may be determined based on the unique IDs maintained by the foundational model as it generates the response incorporating the information provided by the information model. In this manner, the disclosed systems and methods can provide a user a way to verify the accuracy of facts provided in the summary contained in the query response.

In some embodiments, the control system 205 may be configured to provide context-specific dialogue generation. In a conversation with the user interface, the user may input new queries, or modify the query by providing additional entries to the discussion. For example, the user can continue an existing discussion with a chat-bot, voice assistant, or the like, by saying “but what about California.” Accordingly, the control system 205 may generate additional data and parameter sets related to the user provided query from the information model 201 and provide it to the foundational model 203. The additional information about the user query (e.g., California) may allow the foundational model to answer the original user query more informatively. For example, the control system 205 may be configured to check whether all relevant information about California was already sent to the foundational model 203, and if not, it will add the additional relevant information from the information model 201 and then pass the refinement request to the foundational model 203.

In some embodiments, the control system 205 may provide user-specific context awareness. For example, the control system may also be able to extend the context window for a conversation by storing and appropriately incorporating prior conversations into the context provided to the foundational model 203. When a new session with the user interface 207 is initiated but where the user may reasonably expect the system to know the context of prior conversations, the foundational model 203 may be provided with this historical dataset of prior interactions between the system and the user. This information can easily be user specific, and thus would form a user-specific and context aware customization to the overall user experience.

The control system 205 may validate the generated query response by adjusting the language, context, or variable naming of the query response to conform to the language, context, or variable naming conventions of the enterprise. In some embodiments, the control system 205 may also use developer context controls to override the user prompt to enforce enterprise level standards for what kinds of interactions are acceptable to the enterprise.

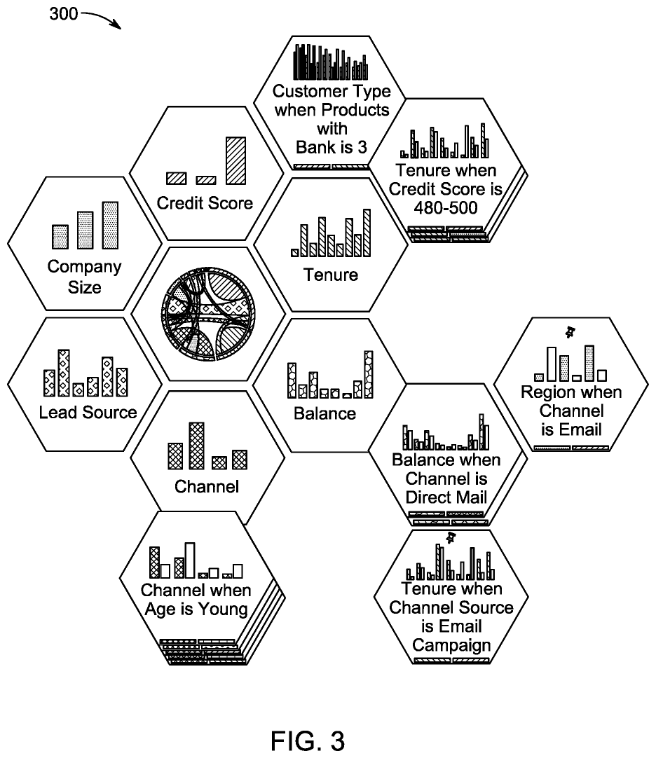

FIG. 3 is an interface showing plots, graphs and other visualizations that illustrate an example of the dataset specific to an enterprise and a parameter set specific to the enterprise as determined by the information model. For example, the information model may generate n-dimensional mappings and charts based on the data that can then be provided to the foundational model by the control system via a graphical user interface 300. For example, as illustrated in an enterprise, the dataset specific to the enterprise may include parameters such as customer type, products with bank, credit score, company size, tenure, lead source, balance, channel, region, balance when channel is direct mail, tenure when channel source is email campaign, channel when age is young, and the like.

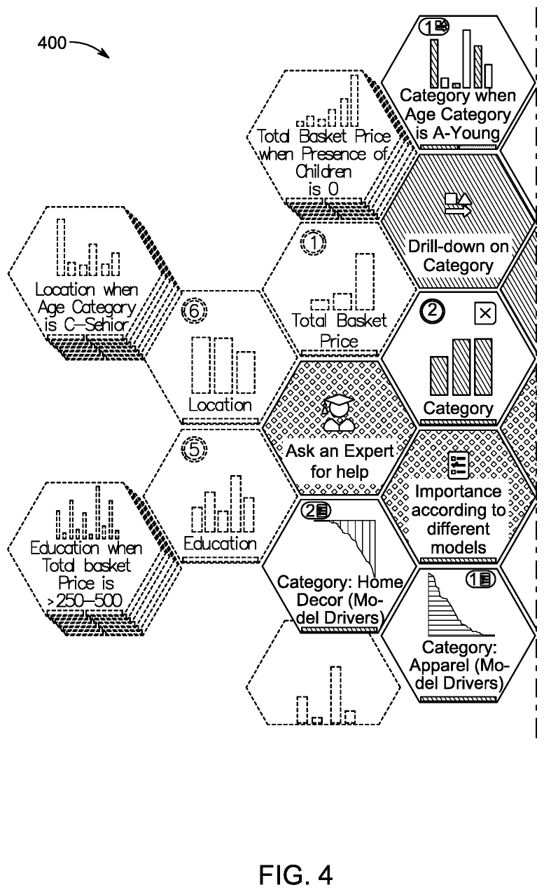

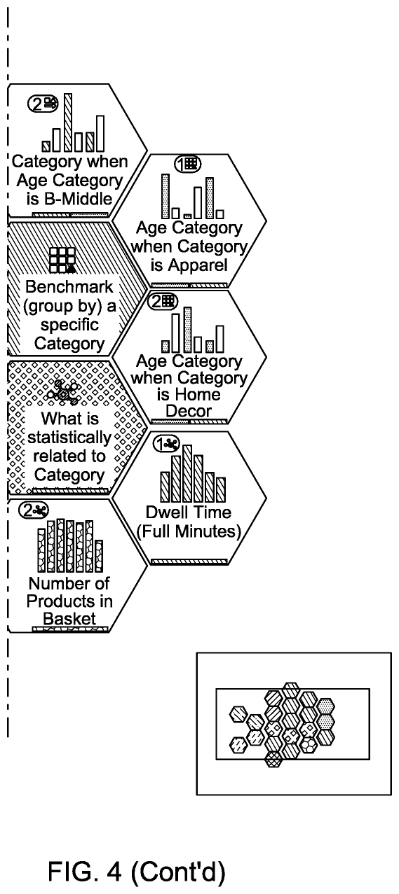

FIG. 4 is an interface 400 also illustrating an example of the dataset specific to an enterprise and a parameter set specific to the enterprise as determined by the information model. As illustrated in FIG. 4, parameters may include a variety of information related to the results of group-by, drill-down, benchmark, statistical association, model driver, Shapley Additive Explanations (SHAP) values, regression coefficients, inclusion probabilities and other related types of queries typically used in analytics and data science. The dataset specific to the enterprise may be provided in any suitable format, including for example, text summaries, images, numbers, tables, formulae, or any combination thereof.

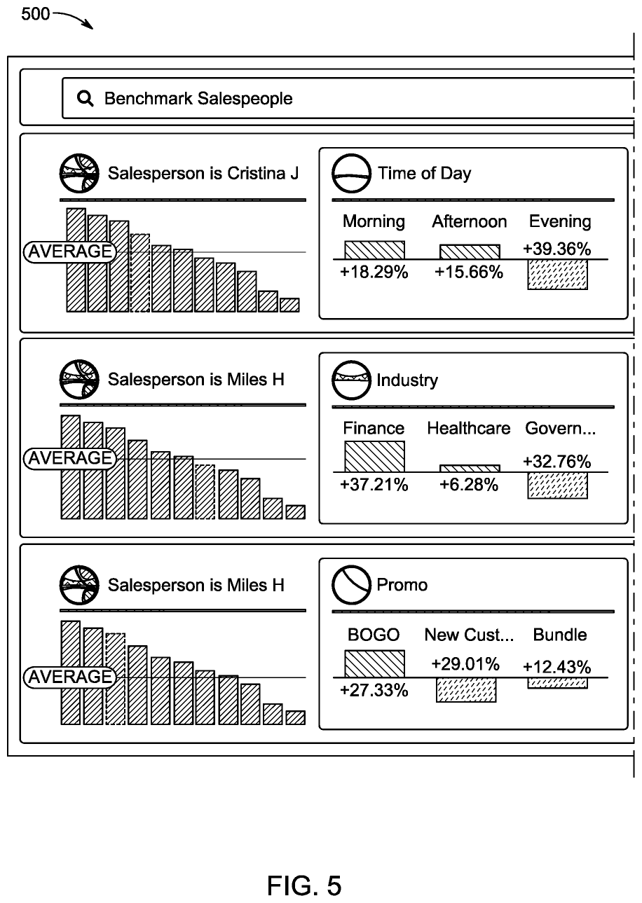

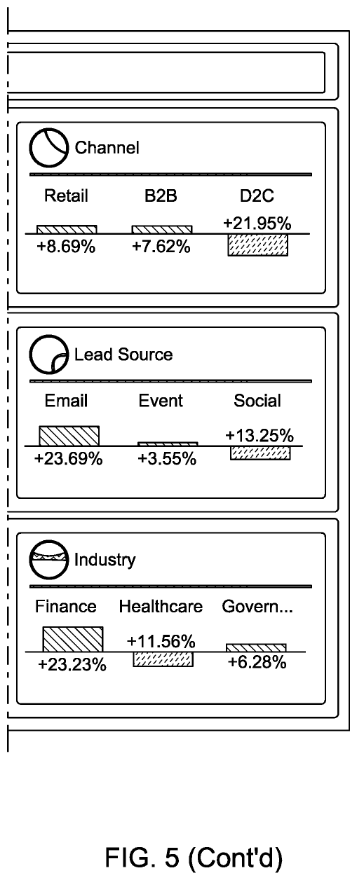

FIG. 5 provides an illustration of the dataset specific to the enterprise and the parameter set specific to the enterprise. As illustrated, the dataset and parameter set may be provided to a user via a graphical user interface 500. The user may be able to search, curate, moderate, or select data and/or parameters that are most relevant to provide to the foundational model. As illustrated, in some embodiments, the user may be able to sort the parameters of a dataset by their increasing effect or relevance on the outcome. For example, in FIG. 5, the infographic demonstrates the relative impact of the variable-value on the selected outcome of the analysis.

In some embodiments, the impact of each parameter in the parameter set may be based on Shapley Additive Explanations (SHAP) values, that explain which variable or parameters are input and how the predictions in the information model are based on those variables or parameters. For example, the net effect of each parameter may be calculated based on the SHAP values of the variable and interactions. In some embodiments, the mean absolute SHAP value may be calculated for all variables and pairs of variables. The mean absolute SHAP value can be used to generate a measure of absolute impact on the outcome for each variable that can be decomposed into the importance of that variable on its own as well as that variable in combination with other variables. The net impact of individual values of a variable may be measured by analyzing the change in the variation of the outcome explained when that value is known against when that value is not known across a wide range of conditions. This data and information can be used to identify circumstances where there are large net deviations in the outcome that are explained by a given value. In some embodiments, other techniques such as using regression coefficients or inclusion probabilities may be used to conduct such analysis.

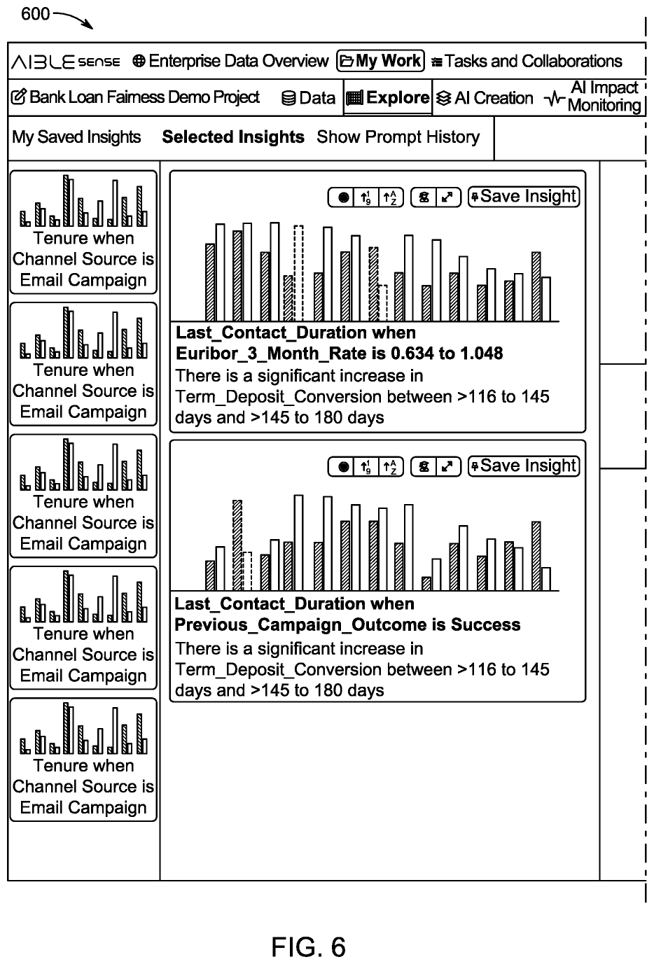

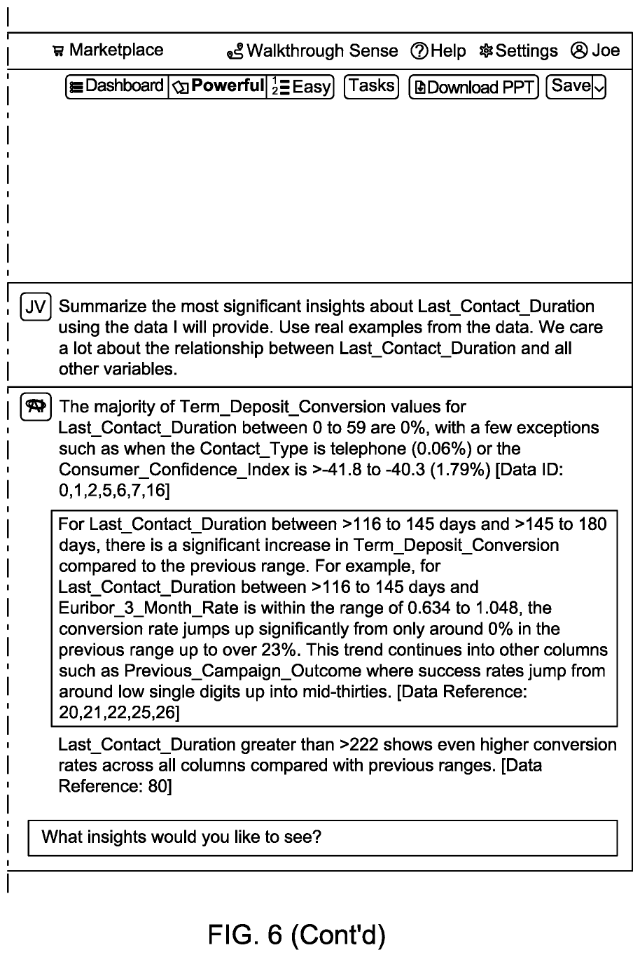

FIG. 6 provides an example user interface 600 illustrating example implementations of the current subject matter, including when the information model produces a narrative text summary of the data that may then be provided to a user via the control system and user interface device. For example, the narrative summary may provide an indication of the most important or interesting elements of the chart and provide a summary of how behavior of a subgroup may deviate from an overall population, and the importance of such a deviation. The importance of a deviation may be determined by a statistical metric such as a T-test. In the illustrated example, the user interface 600 is provided with a user generated query that asks for a summarization about the most significant insights regarding a particular parameter (e.g., Last Contact Duration). In response, the information model provides a text based, narrative summary, of the spread of the data, and important trends related to the particular parameter. The narrative summary provides a complement to the graphical display and charted data.

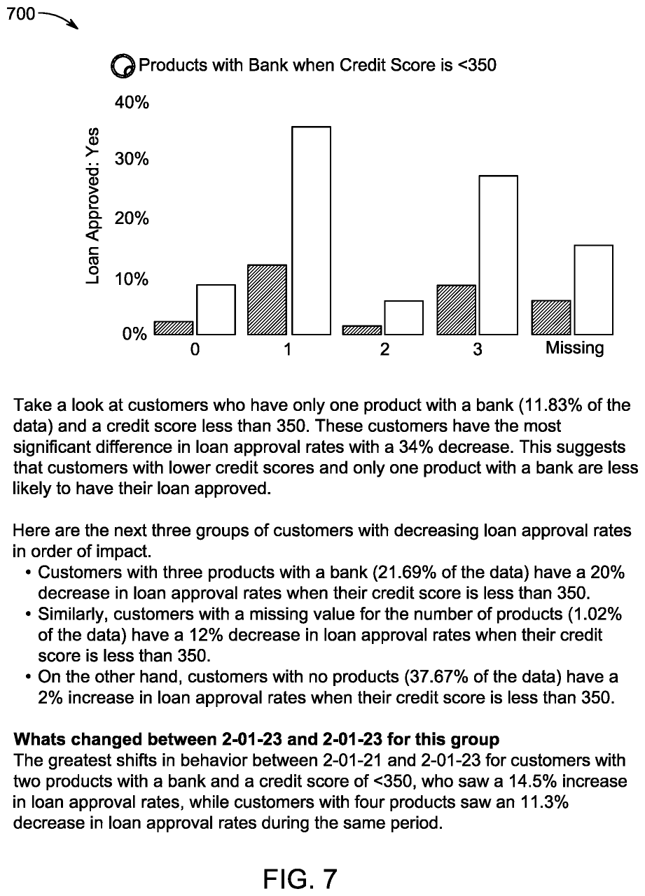

FIG. 7 provides an example user interface 700 illustrating an example implementation of the current subject matter, including where a narrative text summary is provided by an information model. As illustrated, the narrative text summary may provide a summary of information provided by a chart including insights and trend information that may not be obviously visible to a user from the chart.

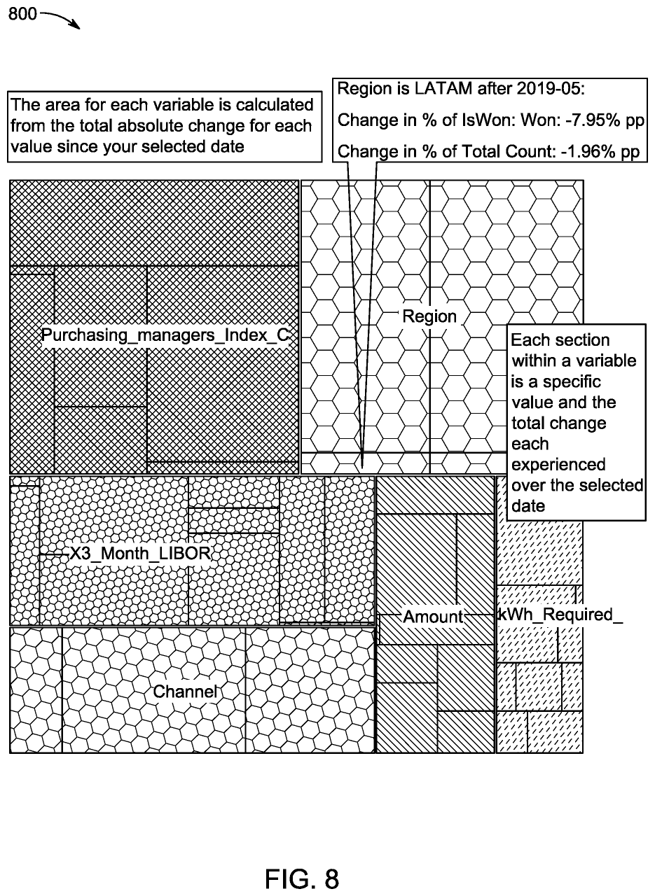

FIG. 8 provides an example user interface 800 illustrating an example implementation of the current subject matter, including where the information model can be updated over time as the underlying data changes. In some embodiments, the user interface may be provided with a charts and infographics that illustrate underlying data changes. For example, the underlying data changes may include both population changes such as the percentage or count of customers from California has changed, as well as behavior changes such as the purchase size or conversion rate for customers from California has changed.

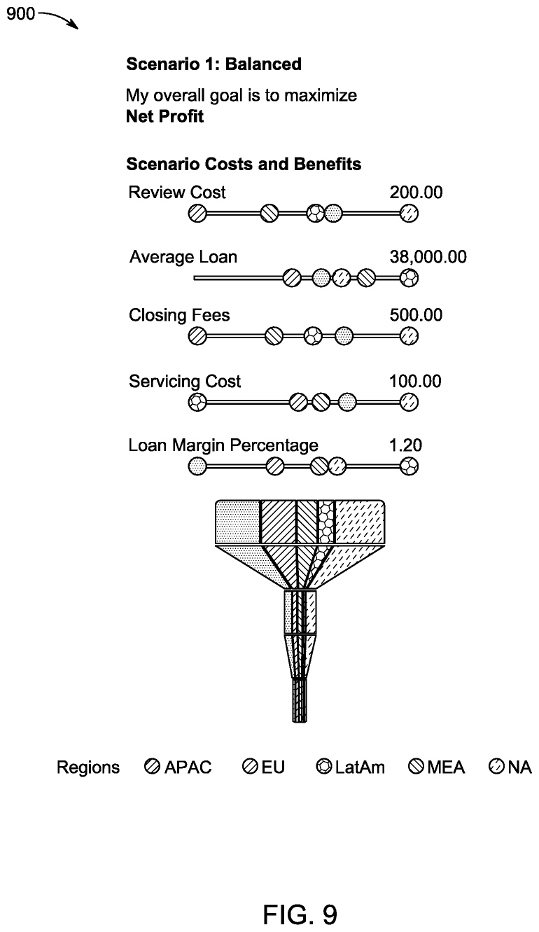

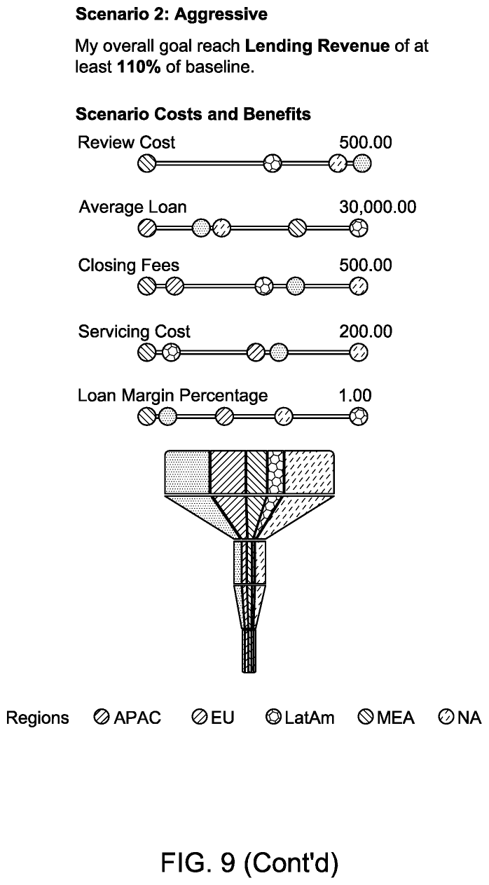

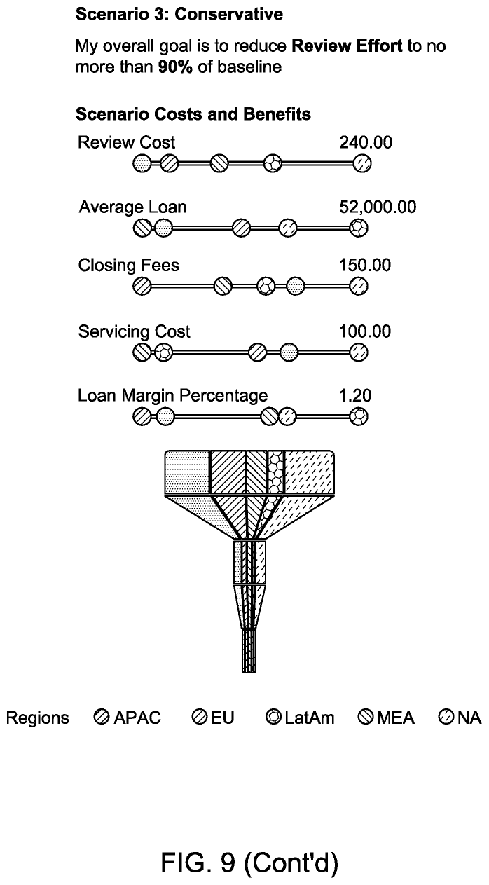

FIG. 9 provides an example user interface 900 illustrating an example implementation of the current subject matter, including where the information model may provide a user with an overview of various scenarios and models that are predictive, prescriptive or optimization models. For example, in FIG. 9, the user interface provides the user with charts explaining how the business may be affected under different strategies and cost benefit assumptions. The same information may be provided to the foundational model and it may even be allowed to recommend different assumption setting and strategies that the control system can test with the information model and provide the results to the foundational model.

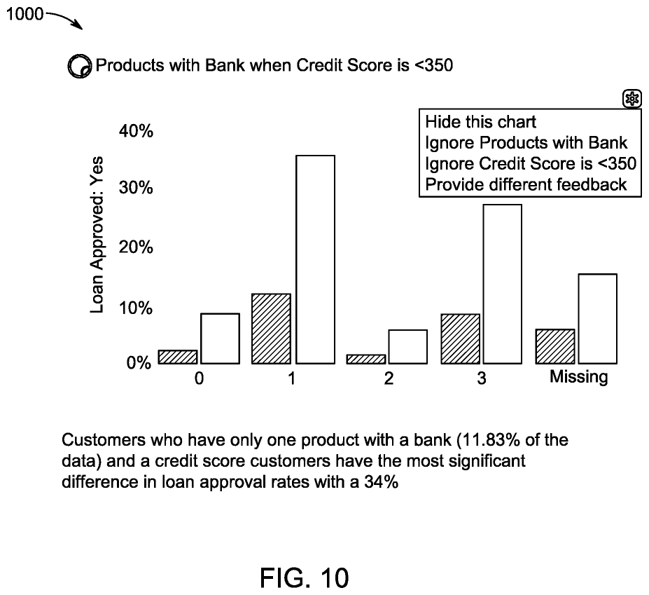

FIG. 10 provides an example user interface 1000 illustrating an example implementation of the current subject matter, including where the information model may provide a user with an overview of credit score information. As illustrated in FIG. 10, the user may have the ability to curate the data provided to the foundational model. As illustrated, the user may have the ability to hide the data from the foundational model, ignore parameters in the data set, or provide alternative recommendations to the information model.

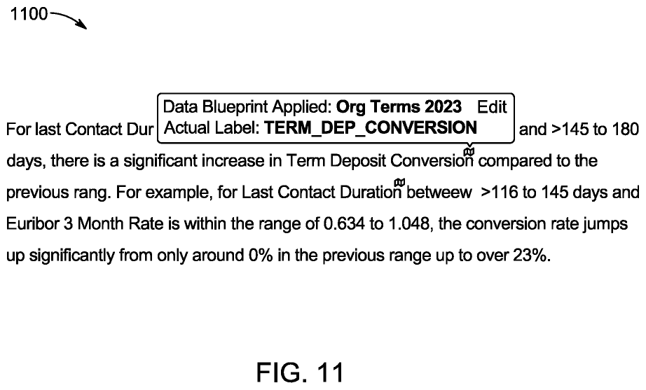

FIG. 11 provides a snapshot from an example user interface 1100 illustrating an example implementation of the current subject matter, including where the control system provides a user with a mapping that replaces the user provided variable name with an enterprise specific variable name that is then provided to the foundational model or the information model.

In some embodiments, after the dataset specific to the enterprise and the parameter set specific to the enterprise is provided to the foundational model, the foundational model may be able to provide analysis over a diversity of parameters. For example, the foundational model may generate a query response that provides a summarization across multiple parameters including average revenue, win rate, sales effort when provided with a sales dataset from the information model and a user query (e.g., “what kinds of opportunities should I focus on given my sales effort costs, likelihood of success, and expected revenue if we win the opportunity?”)

In this manner, the query responses determined by the foundational model that is provided with the dataset specific to the enterprise may provide more accurate and targeted responses to a user query. In another example, the foundational model may provide a query response that provides a summarization of multiple parameters including average revenue, win rate, sales efforts across a sales dataset, stockout statistics, inventory levels, shipment expedite costs across a logistics dataset, and timely payment likelihood and collections metrics from a finance dataset, in response to a user query. The user query may be in natural language form (e.g., “what kinds of opportunities should I focus on if I want to maximize my cash flow in the next two months given my sales effort costs, likelihood of success, expected revenue, my inventory on hand, and collections timeframes?”) In this manner, the user query may guide the dataset specific to the enterprise that is provided to the foundational model. Here, the finance dataset, logistics dataset and sales datasets are provided to the foundational model based on the user query.

In some embodiments, the foundational model may be presented with a plurality of submodels each associated with a different strategy, cost-benefit, constraint setting or the like. In some embodiments, the user or the control system may provide the foundational model with the plurality of submodels and the foundational model may be configured to apply the submodels and incorporate the results of the corresponding optimization model in its summarization step. In such cases each scenario or submodel tried by the foundational model may be associated with a unique identifier. The unique identifier would be presented to the user in the query response if the particular submodel or scenario was used in the summarization provided in the query response. In some embodiments, users can be provided a listing of the unique identifier via the graphical user interface and be able to associate the query response with the particular submodel or scenario. In some embodiments, users can provide acceptable ranges for the different business constraints and then ask the foundational model to create a scenario that optimizes goals of the enterprise within those ranges. In some embodiments, users may adjust the optimization scenario provided to the foundational model to be more realistic and then ask the foundational model to adjust the previous summary in light of the adjustments.

In some embodiments, the control system could use the costs, benefits, constraints information in the information model to inform the foundational model such that it can associate an estimated business impact to patterns in the data.

The control system may be able to view trends in key parameter indicators for the enterprise over time.

In some embodiments, the control system may apply the foundational model across different optimization models provided by the information model, so as to generate globally optimal strategies for the enterprise. An example of applying a foundational model across different optimization models is described in U.S. patent application Ser. No. 17/155,458, filed on Jan. 22, 2021, and entitled “Training and Deploying Models Using Global Resource”, the entire contents of which is hereby expressly incorporated by reference.

In some embodiments, the control system may interface with the foundational model for each task specified in a series of microtasks. For example, the foundational model may determine query responses that provide human comprehensible summaries that correspond to specific sub-tasks or performance guides that are recommended to the user. The control system may be configured to allow users to review and optionally adjust the settings of the sub-tasks and ask for updated summaries or query responses. The control system and the information model may validate the query responses provided by the foundational model.

In some embodiments, if the query responses are associated with software code, the control system and user interface may validate that the code associated with the query responses fit within a restricted code format. In some embodiments, the code associated with the query response may be presented to a user via the user interface for end user confirmation.

In some embodiments, the combined system of the control system, information model and foundational model may be used to identify and explain problems with the underlying dataset associated with the enterprise. For example, the combined system may determine that a portion of the parameter set is missing data, or a top level of data is present but sublevels are not, or any other anomalies with the data. For example, the system may indicate that while it has revenue data, it does not have cost data and that might be useful for the analysis. In another example, the system may flag that it has invoice header data but not the line items. In yet another example, the system may point out anomalies such as there is no data from California even though there is data from all other major states, or that data from a certain date range is missing.

Although a few variations have been described in detail above, other modifications or additions are possible.

In some embodiments the control system may automatically initiate data transformation by requesting that the foundational model generate labels for variables in the parameter set provided by the information model that are in natural language form.

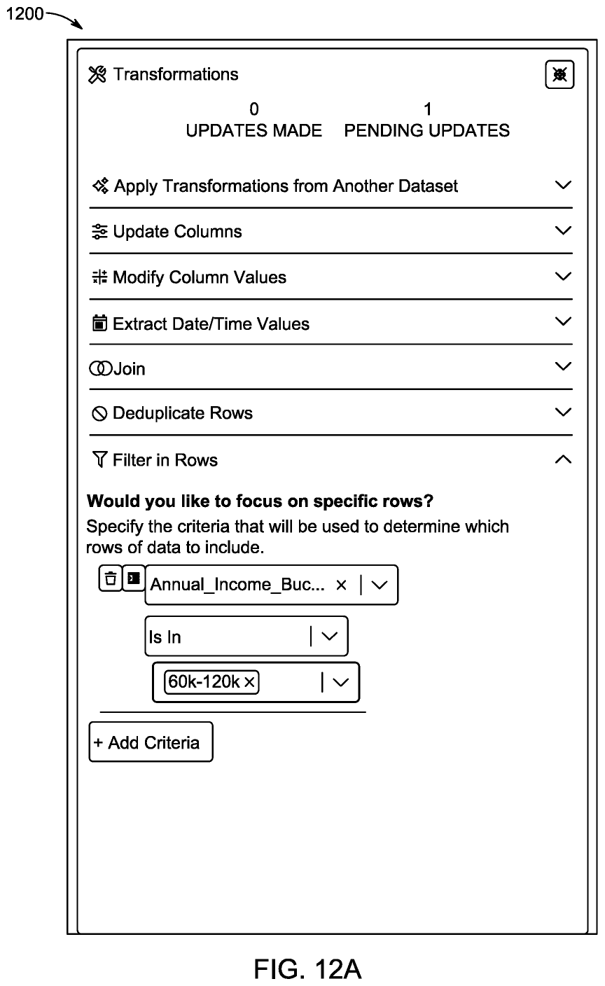

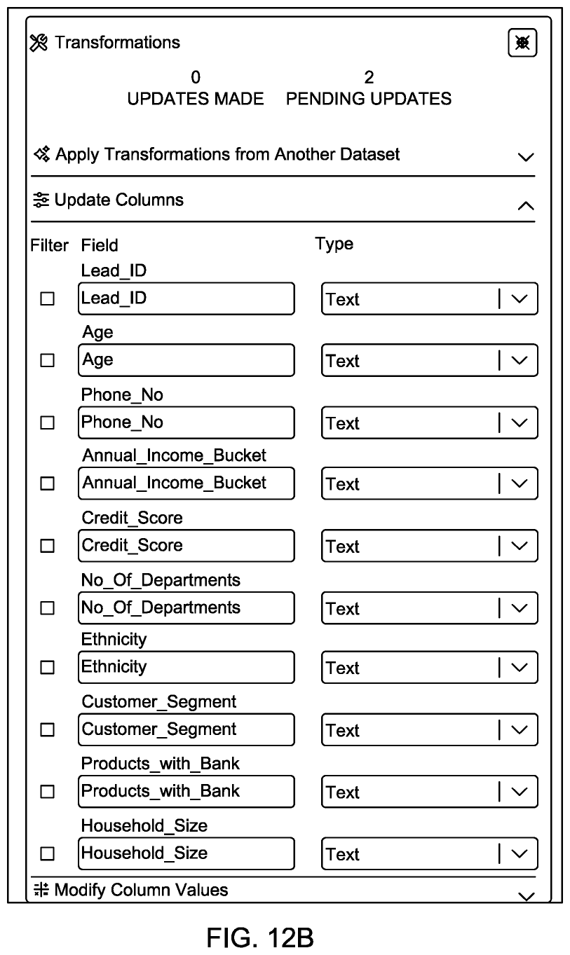

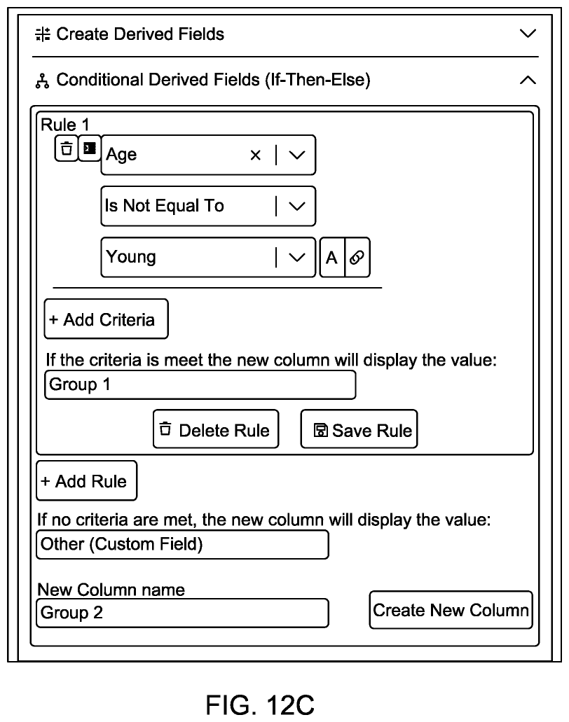

FIG. 12 illustrates an example user interface 1200 illustrating an example implementation of the current subject matter, including a graphical user interface 1200. For example, in some embodiments the described system including the control system, information model, and foundational model may be used to generate data transformation code in an automated manner. For example, the data transformation code may be generated by the foundational model and provided in a manner that allows for it to be used across a plurality of users. In such an embodiment, the user interface may be further configured to allow the user to describe a data transformation using natural language. For example a user may enter a query such as “combine my sales and marketing data by leadID” or “calculate revenue per square foot.” The control system may then transform the user provided query into data characterizing the user provided natural language query. The resulting data characterizing the user provided query may ask the foundational model to generate code in a specific restricted format based on the variable datasets and variables provided by the information model. The foundational model may then determine a query response that provides the requested data transformation. The query response may be in the form of software code. The control system may be further configured to validate the query response and more particularly, the software code by transforming the software code into one or more subtasks that are presented back to the user for validation. The software code subtasks may be presented to the user in natural language form or a simple graphical user interface. As illustrated in FIG. 12, in some embodiments, the control system, information model, and foundational model may be communicating via code, however the user experience only requires the user to understand and approve the transformation as presented in natural language form via a simple user interface. As illustrated, the user may select data transformations that they would like to apply. In some embodiments, the software code that results in the data transformation is only executed once validated by the user, providing additional privacy and security to the enterprise. In some embodiments, the control system may recommend a data transformation as generated in a query response by the foundational model to other users if their data matches the data on which the generated transformation was conducted.

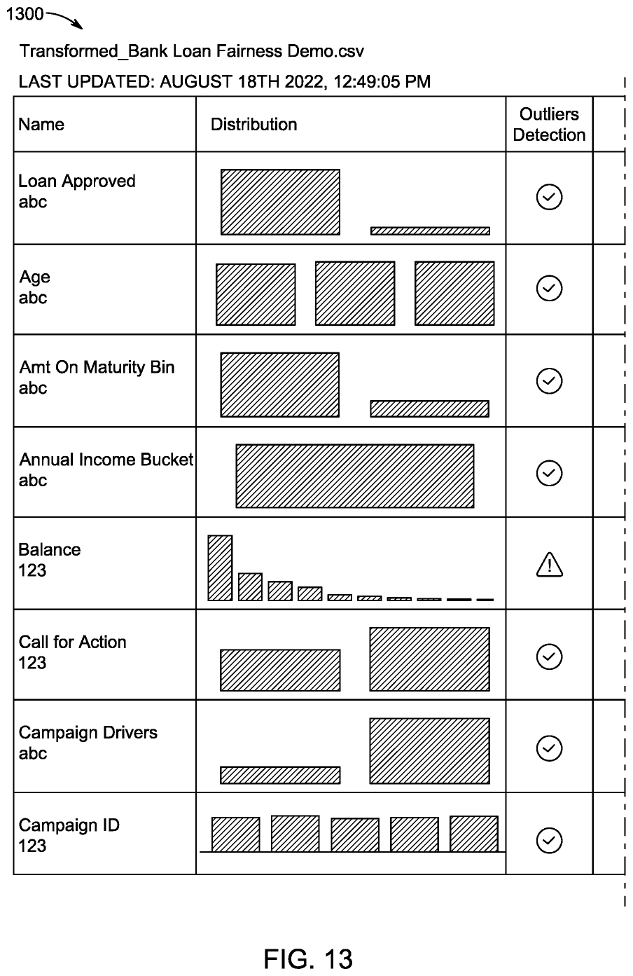

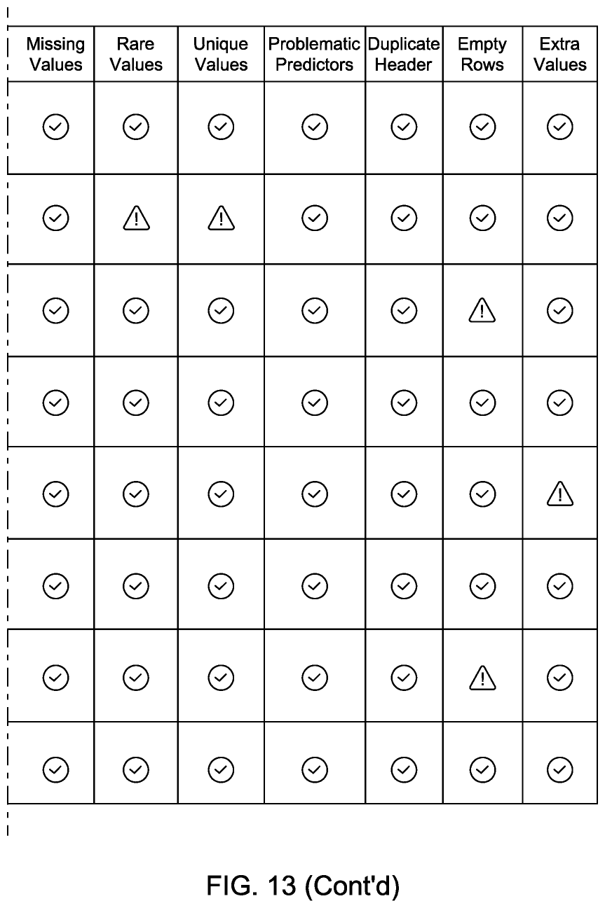

FIG. 13 provides a snapshot from an example user interface 1300 illustrating an example implementation of the current subject matter, including where the control system provides validation of the query response. As illustrated, the control system may provide the user with a graphical representation of the underlying data as well as the parameters and provide indicators for any problems. Examples of data validation flags include outlier detection, missing values, rare values, unique values, problematic predictors, duplicate headers, empty rows, extra values, and the like.

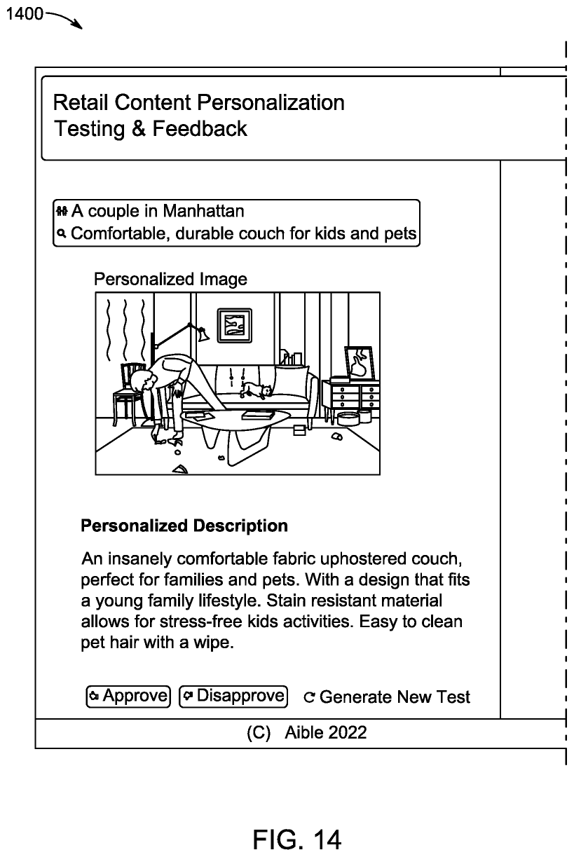

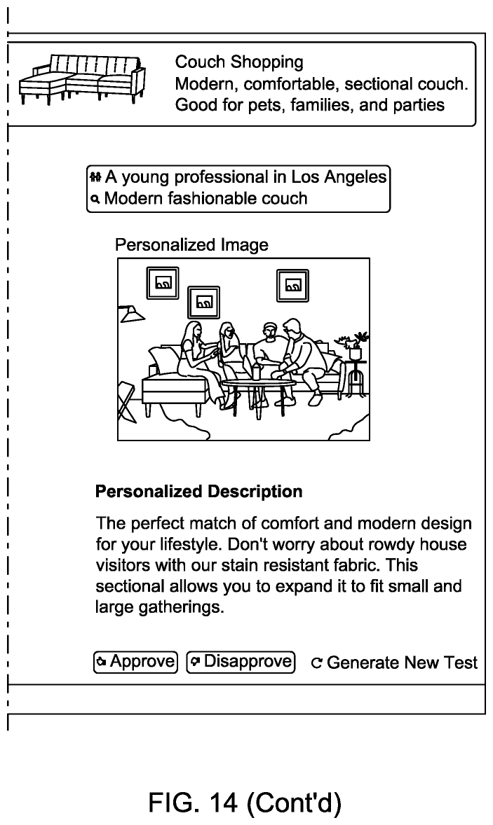

FIG. 14 provides an example user interface 1400 illustrating an example implementation of the current subject matter, including where the foundational model is used to generate personalized content for a landing page for an enterprise. For example, the foundational model may be used to generate a landing page experience based on the user's search query (e.g., “couch”, “furniture”) and what the information model knows about the user (e.g., “couple”, “young professional”, “lives in Boston”, “Age: 30”, “Male”).

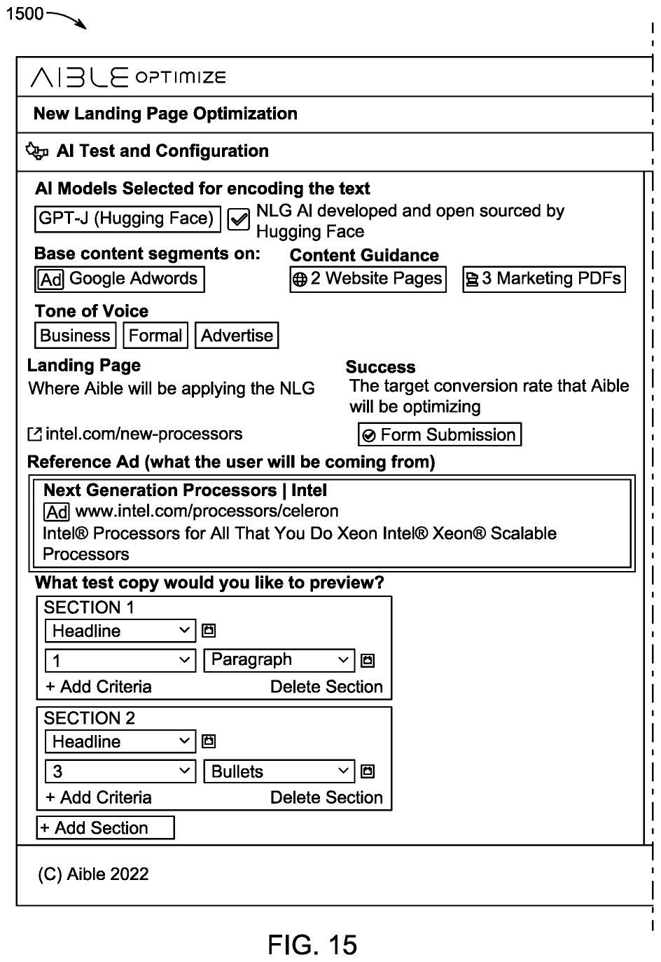

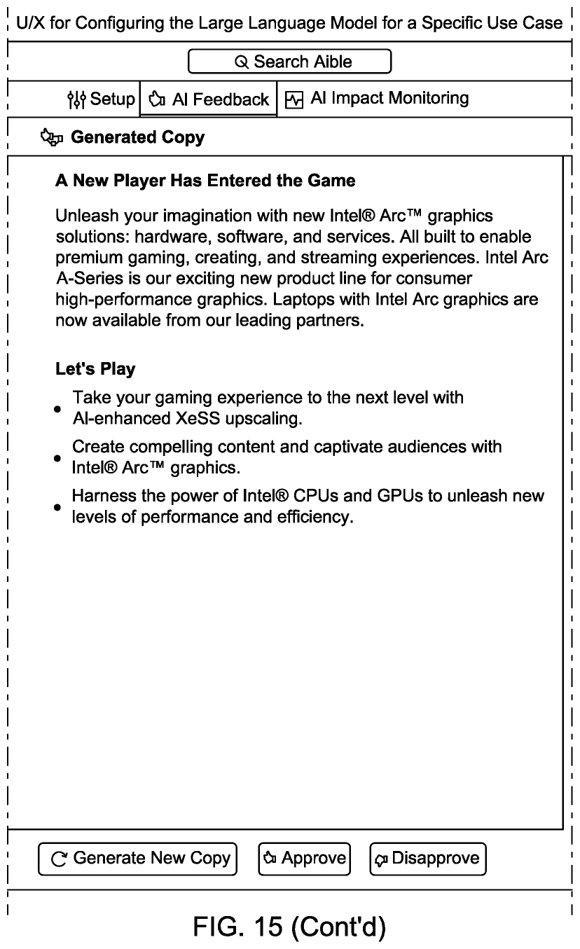

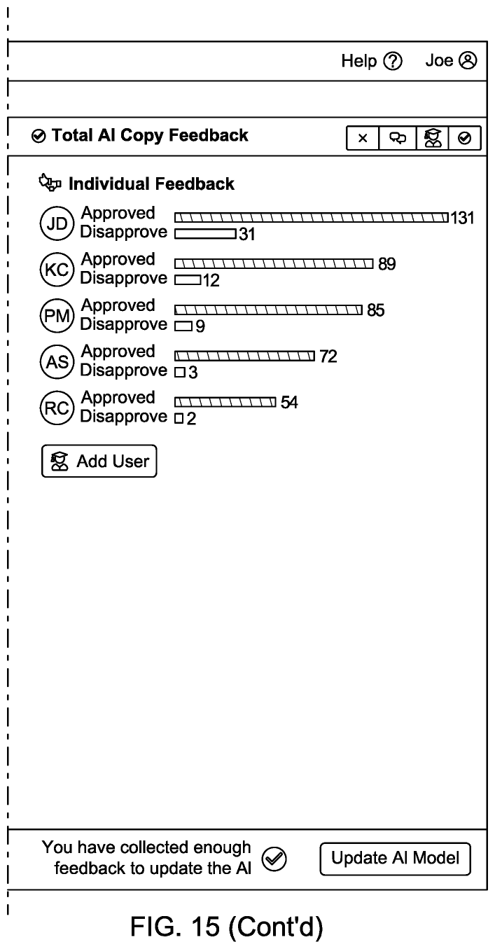

FIG. 15 provides an example user interface 1500 illustrating an example implementation of the current subject matter, including where the control system is used to configure the foundational model for a specific use case. As illustrated, various AI models may be provided to the user for selection. The user may then select content segments, content guidance, tone of voice, and generate copies of AI-generated responses.

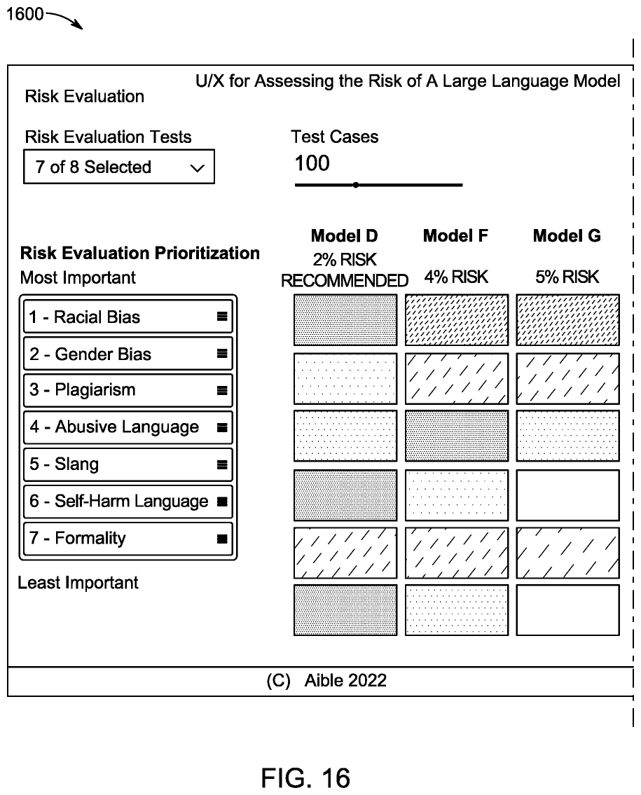

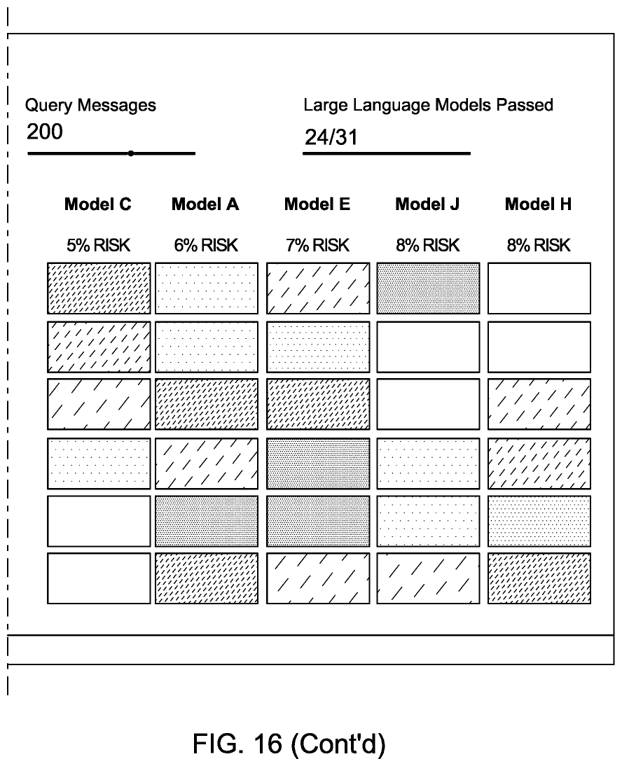

In some embodiments, the described control system and user interface may be used to validate the foundational model by performing bias and plagiarism tests. In such embodiments, the control system and information model may generate test cases based on the data, test different foundational models and settings, and present the determined risk back to the user using the user interface. FIG. 16 provides an example user interface 1600 illustrating an example implementation of the current subject matter, including where a plurality of models (e.g., Models D, F, G, C, A, E, J, and H) are being evaluated based on a prioritized list of parameters including racial bias, gender bias, plagiarism, abusive language, slang, self-harm language, and formality. Various other parameters are envisioned.

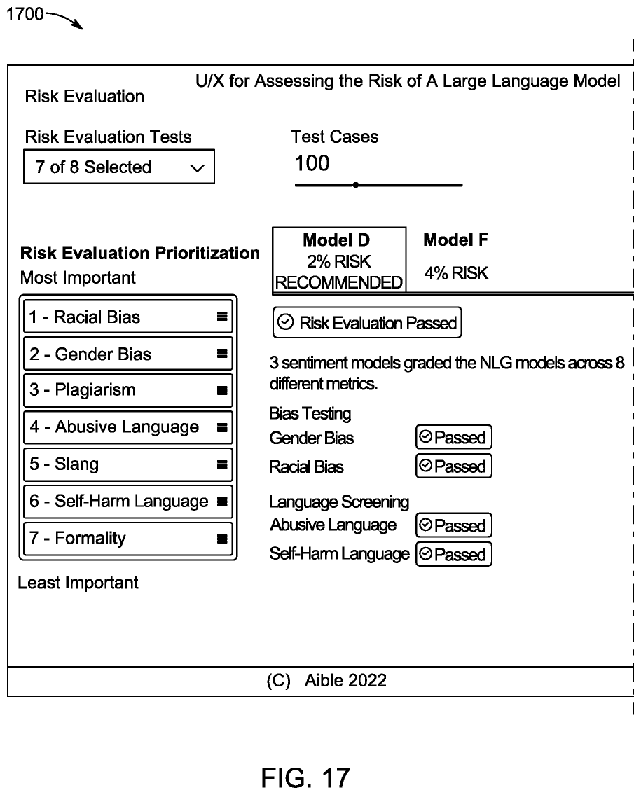

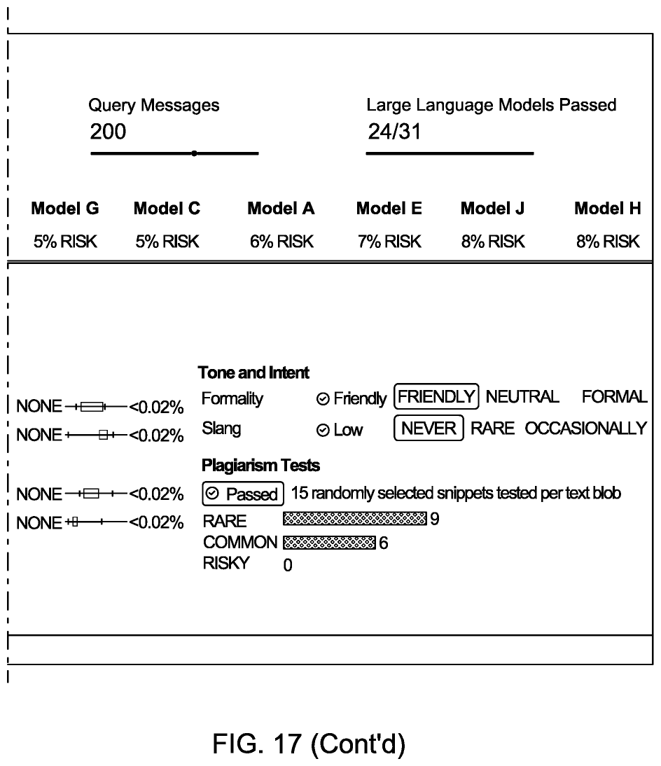

FIG. 17 provides a further example of a user interface 1700 illustrating an example implementation of the current subject matter, where the user interface is used to assess the risk of a foundational model. As illustrated, the user interface may provide a user with detailed risk assessments that can be easily reviewed and allow the user to adjust corresponding settings of the underlying AI models.

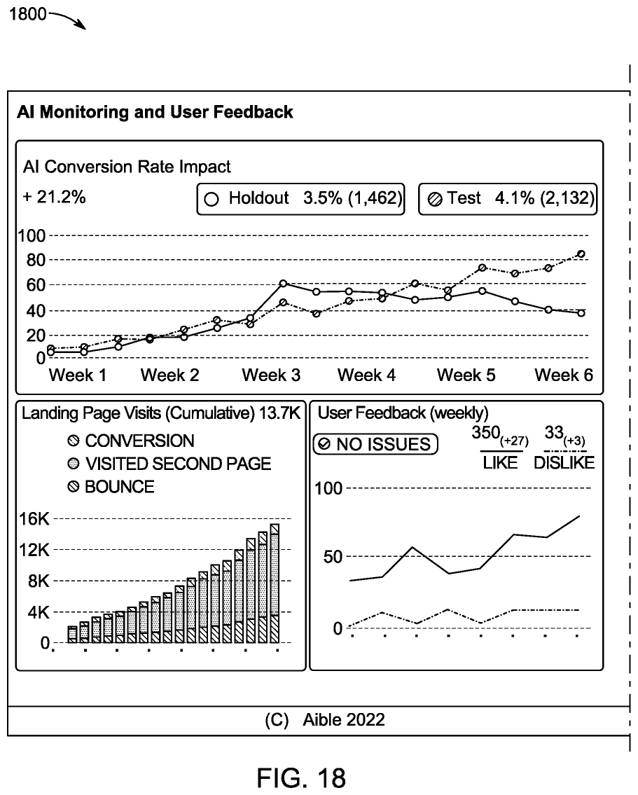

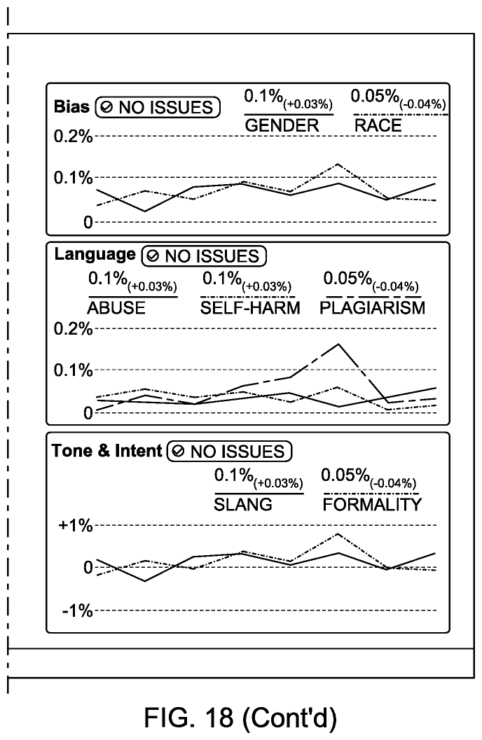

FIG. 18 provides a further example of a user interface 1800 illustrating an example implementation of the current subject matter, where the user interface is used to monitor the performance of a foundational model over time.

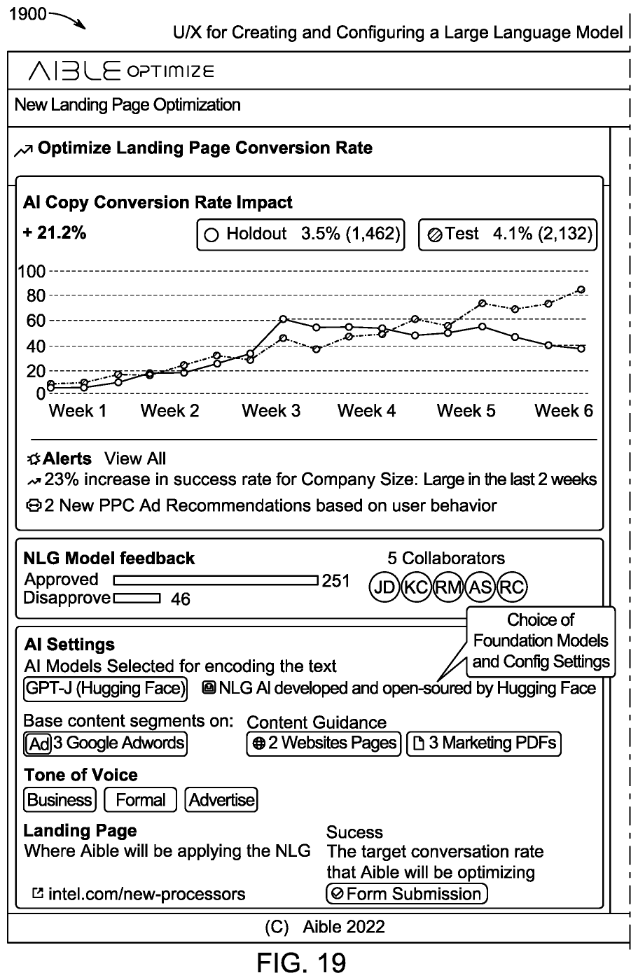

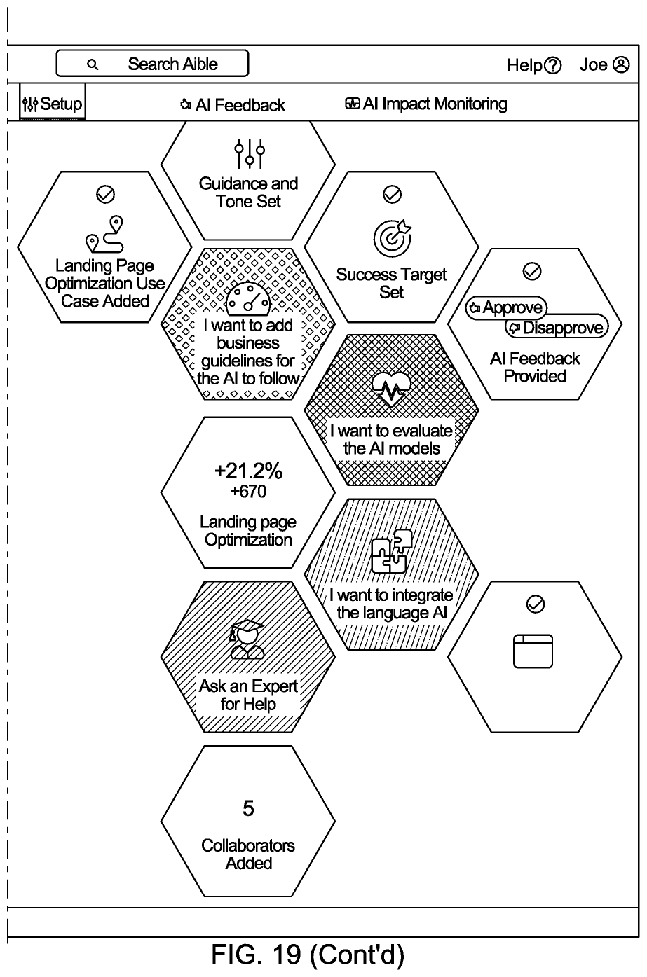

FIG. 19 provides a further example of a user interface 1900 illustrating an example implementation of the current subject matter, where the user interface is used to create and configure a foundational model. Foundational models may be expensive to train or operate. Accordingly, the user interface 1900 may allow a user to view if different foundational models have slightly different impacts on business objectives but very different execution costs, allowing a user to weight the impact on business objective with the cost to determine which model is the best fit for their requirements.

Foundational model approaches can also be used with optimization models, which are described in U.S. application Ser. No. 17/232,667, filed Apr. 16, 2021, and entitled “Impact Score Based Target Action”, the entire contents of which is hereby incorporated by reference herein. The foundational model approaches can be used with optimization models by, for example, adjusting the foundation model settings to effectively increase customer conversion rates based on different landing page copy generation algorithms and their associated cost of execution. The different risk levels for different foundation models and settings can be incorporated into such cost-benefit optimization by incorporating an expected cost multiplier for each risk type.

Although the above example has been described with respect to using a foundational model, some implementations of the current subject matter can utilize any type of global learning model. A global learning model may be a model that is trained on a vast quantity of data and may utilize various learning algorithms including supervised and unsupervised techniques. A foundational model may include artificial intelligence based models that are trained on vast quantities of data. In some embodiments, foundational models may be capable of being trained on a broad set of unlabeled data for use with different tasks.

The subject matter described herein provides many technical advantages. For example, the described subject matter provides improved privacy, enterprise specific context aware responses, and reduces hallucinations in existing AI-based generative systems. They simplify the user's ability to quickly double check the accuracy of generated responses. They enable optimization of the business outcome against the cost of finetuning or operating the foundational models.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving, at a processor, data characterizing a query at a user interface;
obtaining, by an informational model, a dataset characterizing an enterprise associated with the received query;
obtaining, by the informational model, a dataset characterizing a parameter set for the enterprise associated with the received query;
determining, by a trained foundational model, a response to the received query based on at least one of the trained foundational model, the obtained dataset characterizing the enterprise, and the obtained dataset characterizing the parameter set; and
providing, the determined response to the received query to a user.

2. The method of claim 1, wherein obtaining the dataset characterizing the enterprise associated with the received query further comprises:
determining the enterprise associated with the received query;
providing the informational model associated with the enterprise the data characterizing the query; and
receiving, by the informational model, data related to the enterprise responsive to the received query.

3. The method of claim 1, wherein obtaining the dataset characterizing the parameter set for the enterprise associated with the received query further comprises:
determining the enterprise associated with the received query;
providing the informational model associated with the enterprise the data characterizing the query; and
receiving, by the informational model, parameters related to the enterprise responsive to the received query.

4. The method of claim 1, wherein the informational model is communicatively coupled to at least one of a network or a database associated with the enterprise, and wherein the foundational model has limited access to the network or database associated with the enterprise.

5. The method of claim 1, further comprising:
validating, by the trained foundational model, the response to the received query, wherein the validating further comprises:
encoding data from at least one of the dataset characterizing the enterprise or the dataset characterizing the parameter set with an identifier;
maintaining the identifier in the generated response; and
providing the identifier within the query response.

6. The method of claim 1, wherein determining the response to the received query further comprises applying the trained foundational model on data characterizing at least one of a historical query or a response to a historical query.

7. The method of claim 5, wherein validating the response to the received query further comprises adjusting the language, context, or variable naming of the response to the received query to conform to the language, context, or variable naming conventions of the enterprise.

8. The method of claim 1, wherein the trained foundational model comprises at least one of a generative model, a multimodal model, a reinforcement learning model, transfer learning model, and a large language model.

9. The method of claim 1, wherein the informational model comprises at least one of a descriptive model, diagnostic model, predictive model, prescriptive model, optimization model, a cost-benefit model, a constraint model, or a digital twin.

10. The method of claim 9, wherein an optimization model comprises a set of models trained on a dataset using a set of resourcing levels and performance indicators.

11. The method of claim 9, wherein a cost-benefit model comprises a model trained to classify an event as belonging to a first event type or a second event type, wherein the classification of the event is responsive to at least one of an impact of correctly treating the event as belonging to a first event, an impact of erroneously treating the event as belonging to the first event, a cost of erroneously treating an event as not belonging to the first event, and a benefit of correctly treating an event as not belonging to the first event.

12. The method of claim 9, wherein a constraint model comprises a model trained based on one or more resource constraints of the enterprise.

13. The method of claim 1, further comprising:
generating a query for the information model based on the received query at the user interface by applying context specific data.

14. The method of claim 1, wherein the dataset characterizing the enterprise comprises at least one of key performance indicators, revenue, win rate, costs, budgets, statistics, inventory levels, logistics datasets, collections metrics and lead conversions.

15. The method of claim 1, wherein at least one of the dataset characterizing the enterprise and the dataset characterizing the parameter set comprises text summaries, images, number, tables, or formulae.

16. The method of claim 1, wherein the query is provided by the user interface in natural language form.

17. The method of claim 1, wherein the dataset characterizing the parameter set comprises key performance indicators for the enterprise.

18. The method of claim 1, wherein the foundational model comprises a learning model, the learning model trained via reinforcement learning from human feedback.

19. The method of claim 1, wherein the determined response is provided to the user interface in natural language form.

20. The method of claim 1, further comprising:
modifying at least one of the parameters of the foundational model based on the dataset characterizing the parameter set.

21. The method of claim 1, further comprising:
training at least a portion of the foundational model based on the dataset characterizing the enterprise.

22. The method of claim 21, wherein the foundational model comprises a transfer learning model and the dataset characterizing the enterprise comprises additional training data for the transfer learning model.

23. A system comprising:
at least one data processor; and
memory coupled to the at least one data processor and storing instructions which, when executed by the at least one data processor, causes the at least one data processor to perform operations comprising:
receiving, at a processor, data characterizing a query at a user interface;
obtaining, by an informational model, a dataset characterizing an enterprise associated with the received query;
obtaining, by the informational model, a dataset characterizing a parameter set for the enterprise associated with the received query;
determining, by a trained foundational model, a response to the received query based on at least one of the trained foundational model, the obtained dataset characterizing the enterprise, and the obtained dataset characterizing the parameter set; and
providing, the determined response to the received query to a user.

24. A non-transitory computer readable storage medium storing computer readable instructions, which, when executed by at least one data processor, causes the at least one data processor to perform operations comprising:
receiving, at a processor, data characterizing a query at a user interface;
obtaining, by an informational model, a dataset characterizing an enterprise associated with the received query;
obtaining, by the informational model, a dataset characterizing a parameter set for the enterprise associated with the received query;
determining, by a trained foundational model, a response to the received query based on at least one of the trained foundational model, the obtained dataset characterizing the enterprise, and the obtained dataset characterizing the parameter set; and
providing, the determined response to the received query to a user.
